(19) United States
(12) Patent Application Publication
(10) Pub. No.: US 2010/0012621 A1
(43) Pub. Date: Jan. 21, 2010

(54) METHOD OF TREATING COPPER SULPHIDE DEPOSITS IN AN ELECTRICAL APPARATUS BY THE USE OF OXIDISING AGENTS

(75) Inventors: Karin Gustafsson, Sollentuna (SE); Robert Leandersson, Vasteras (SE)

Correspondence Address: VENABLE LLP, P.O. BOX 34385, WASHINGTON, DC, 20043-9998, US

(73) Assignee: ABB RESEARCH LTD., Zurich (CH)

(21) Appl. No.: 12/438,733

(22) PCT Filed: Aug. 13, 2007
(86) PCT No.: PCT/SE07/50547

§ 371 Date: Feb. 25, 2009

(30) Foreign Application Priority Data
Aug. 25, 2006 (SE) 0601743-8
Mar. 23, 2007 (SE) 0700748-7

(51) Int. Cl. B44C 1/22; C23F 1/08; C23G 5/00

(52) U.S. Cl. 216/13; 156/345.1; 156/345.37; 134/40

(57) ABSTRACT

A method of treating copper sulfide deposits on materials and surfaces that are in contact with electrically insulating oil inside an electrical apparatus. A substantial amount of the electrically insulating oil, normally present in the electrical apparatus, has been removed. The copper sulfide is subjected to treatment with an oxidizing agent which causes a reaction with the copper sulfide deposits. The oxidizing agent can include any compound from the list; chlordioxide, a peroxy acid or ozone.

### TECHNICAL AREA

The present invention relates to a method of treating copper sulphide deposits present in electrically insulating layers in an electrical apparatus.

### TECHNICAL BACKGROUND

Insulating oils are used in a number of different apparatus in the field of electrical power transmission and electrical power generation, for example; power transformers, distribution transformers, tap changers, switchgear and reactors. The insulating oil is usually a highly-refined mineral oil that is stable at high temperatures and has excellent electrical insulating properties. The functions of the oil are to electrically insulate conductors in the apparatus, suppress corona and arcing, and to serve as a coolant of the conductors in the electrical apparatus.

These electrically insulating oils often contain traces of reactive sulphur compounds, for example, thiols (also known as mercaptans), which may react with copper or oxidized copper, forming copper mercaptides. The copper mercaptides can decompose further, leading to the formation of copper (I) sulfide, Cu₂S.

One reaction path could be as shown below:

Cu₂O+2RSH=>2CuSR+H2O

2CuSR=>Cu2S+RSR

where RSH is a thiol, —SH is a thiol group (or mercaptan), —R is an alkyl group and RSR is a thioether.

Other sulfurorganics, especially sulfides, can also be active, either by direct reaction with copper or via conversion to thiols.

Copper sulphide is insoluble in oil and may form deposits on surfaces and materials in contact with the electrically insulating oils inside the electrical apparatus. For example, large power transformer windings are still mostly insulated with paper, wood, and oil and although these materials have been used for more than 100 years, they still provide a good balance of economy and performance.

The copper sulphide is an electrical semiconductor and the formation of a semi-conducting deposit on surfaces and materials in the electrical apparatus may degrade or disrupt the operation of the apparatus.

If the semi-conducting copper sulphide is deposited on the isolation material (usually cellulose material e.g. paper) used to cover the copper conductors in the electrical apparatus, this might lead to a degrading of the insulation properties of the isolation material which could lead to leak currents or short circuits. Semi-conducting copper sulphide deposits on surfaces of solid isolation materials (such as wood, ceramic, and pressboard) inside the electrical apparatus may also create similar problems.

Semi-conducting copper sulphide deposits directly on surfaces of conductors may create problems, especially if the deposits are formed on connector surfaces.

CIGRE Moscow symposium 2005 “Oil corrosion and Cu2S deposition in Power Transformers”; Bengtsson et al. describes the results of failure analysis and a laboratory reproduction of the copper sulphide Cu₂S deposits on surfaces and materials in power transformers.

WO2005115082 entitled “Method for removing reactive sulfur from insulating oil” describes a method for removing sulphur-containing compounds from insulating oil by exposing the oil to at least one sulphur scavenging material and exposing the oil to at least one polar sorbent.

The method in WO2005115082 was developed for treating the electrically insulating oil already present in an electrical apparatus by removing sulphur-containing compounds in the oil outside of the electrical apparatus which prevents further depositions of copper sulphide on materials and surfaces inside the electrical apparatus. Up to date there is no suggestion of how to treat copper sulphide that has already been deposited on surfaces and materials inside of the electrical apparatus. Currently, the only solution for removal of the depositions of copper sulphide on the insulation paper used to cover copper conductors is to remove the old paper and replace it with new insulation paper.

JP2001311083 describes how sulfur compounds in electrically isolation oils can be removed before the use in an electrical apparatus by storing the oil in a vessel containing copper or copper alloys. The sulfur compounds in the oil react with the copper and are thus captured and removed from the oil prior to the use in the electrical apparatus.

### SUMMARY OF THE INVENTION

One embodiment of the present invention is to provide a method by means of which semi-conducting copper sulphide deposits on materials and surfaces inside an electrical apparatus are treated with an oxidizing agent where a substantial amount of insulating oil in the electrical apparatus have been removed.

One embodiment of the present invention is achieved by means of the initially defined method, characterized in that a oxidizing agent reacts with said copper sulphide deposits on materials and surfaces inside an electrical apparatus and the reaction transforms the copper sulphide deposits to compounds that are less electrically conducting. The copper sulphide is a semiconductor and the formation of a semi-conducting deposit on the isolation material might lead to a degrading of the insulation properties of the insulating material and oil system which could lead to short circuits in the electrical apparatus. These short circuits can be avoided by removing the copper sulphide from the isolation material or transforming the copper sulphide to compounds with lower conductivity.

In one embodiment of the present invention said oxidizing agent comprises chlorine dioxide, ClO₂.

In another embodiment of the present invention said oxidizing agent comprises a peroxy acid R—O₃H.

In another embodiment of the present invention said peroxy acid comprises peracetic acid, C₂H₄O₃.

In another embodiment of the present invention said peroxy acid comprises performic acid, CH₂O₃.

In another embodiment of the present invention said oxidizing agent comprises ozone, O₃.

The materials that are to be treated inside the electrical apparatus by the present method comprise any from the group of: paper, pressboard, wood and other solid/fibrous insulating materials in contact with the electrically insulating oil

The surfaces that are to be treated inside the electrical apparatus by the present method comprise any from the group of: insulated conductors, exposed conductors, magnetic core and other solid surfaces in contact with the electrically insulating oil.

According to an embodiment of the invention a method is provided that further comprising the step of pre-treating the copper sulphide deposits with a substitution agent before the treatment with the oxidizing agent.

The substitution agent reacts with copper sulphide deposits and transforms the copper sulphide to substances that are more easily oxidized by the oxidizing agent. Examples of substitution agents are elementary halogens especially iodine I₂ or chlorine Cl₂.

According to an embodiment of the invention, all remaining oil is removed and the inside of the electrical apparatus are further cleaned by means of a liquid in which the electrically insulating oil is soluble before the treatment with the oxidizing agent.

The present method can be performed on an electrical apparatus where most of the oil has been removed but some oil remain on the surfaces and in materials. The reaction agents, both oxidizing agent and possible substitution agent, are entered in the apparatus as gases and are then adsorbed/dissolved in the oil on surfaces and materials and the reaction occurs mainly in the oil phase.

The present method can also be performed on an electrical apparatus where most of the oil has been removed and then all surfaces and materials inside the apparatus are then further cleaned by solvents. The cleaning of the electrical apparatus by solvents can be done by spraying or washing the inside of the apparatus with solvents which are then removed. The cleaning of the apparatus can also be done by introducing the solvent as a vapor and letting the vapor condensate on surfaces and materials. The condensate is then removed from the apparatus.

Another embodiment of the invention is a system for treating copper sulphide deposits on materials and surfaces inside an electrical apparatus that have been in contact with electrically insulating oil normally present in the electrical apparatus where the electrical apparatus is mostly empty of oil and, the system comprises means for introducing a gaseous chemical agent into the electrical apparatus and, the system comprises means for removing excess atmosphere from the electrical apparatus. In the system, the means for introducing a gaseous chemical agent comprises a temporary connection between a source of chemical agent and the apparatus. The gaseous chemical agent can be either an oxidizing agent comprising chlordioxide, peracetic acid, performic acid, ozone; or a substitution agent comprising iodine or chlorine.

According to an embodiment of the invention the treatment is performed in a controlled atmosphere. The atmosphere is controlled by controlling parameters such as; humidity, temperature, oxidizing agent concentration or partial pressure, nitrogen and oxygen content.

If the step of pre-treating the copper sulphide deposits with a substitution agent is used, the atmosphere is controlled by controlling parameters such as; humidity, temperature, substitution agent concentration or partial pressure, nitrogen and oxygen content.

In order for the reactions to occur in a controlled manner the partial pressure of the gases inside the apparatus have to be controlled. The most important gases to control are; oxidizing agent or substitution agent, nitrogen, oxygen and humidity. The method might require the step of diluting the oxidizing agent or substitution agent with a non-reactive gas, such as nitrogen N₂. The method might comprise the step of dying the gas mixture before injecting it into the apparatus.

The reaction rate is also affected by the temperature in the apparatus and one way of controlling the temperature in the apparatus is by heating the conductors in the electrical apparatus by a current flowing through the conductors another way of controlling the temperature in the apparatus is by using external heaters on the apparatus.

In order for the reactions to occur at a sufficient rate the agents (oxidizing or substitution) have to be transported from the bulk of the atmosphere inside the apparatus to surfaces and materials. To ensure this transport of agents the atmosphere has to be well mixed. One way of mixing the atmosphere inside the apparatus is by having a mixing means placed inside the electrical apparatus e.g. fan, agitator or pump. Another way of mixing the atmosphere inside the apparatus is by extracting part of the atmosphere in the electrical apparatus and feeding it back to said electrical apparatus i.e. having a circulation loop.

After the reactions with the copper sulphide have occurred, the reaction products, mostly non-conducting copper sulphates, are allowed to remain on the materials and surfaces in the electrical apparatus and the electrical apparatus is re-filled with electrically insulating oil and are ready to be used again.

As the agents (oxidizing or substitution) are fed into the apparatus, equal amounts of atmosphere have to be removed from the apparatus to prevent overpressure. This removed atmosphere contains some amounts of unreacted agent and this unreacted agent can not be allowed to enter the outer atmosphere. Therefore the method comprises the step of removing or destroying (by transforming the agent to less active substances) the unreacted agent. For example, in the case of oxidizing agent, by passing the removed atmosphere through a material that is easily oxidized. If the removed atmosphere contains the substitution agent iodine I₂, this iodine can be captured in a cold trap.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated, simplified or enlarged to facilitate an understanding of the invention.

FIG. 1 is a flowchart of one embodiment of the invention.

FIG. 2 illustrates a schematic process diagram of one embodiment of the invention.

FIG. 3 illustrates another schematic process diagram of one embodiment of the invention.

### DETAILED DESCRIPTION OF THE EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

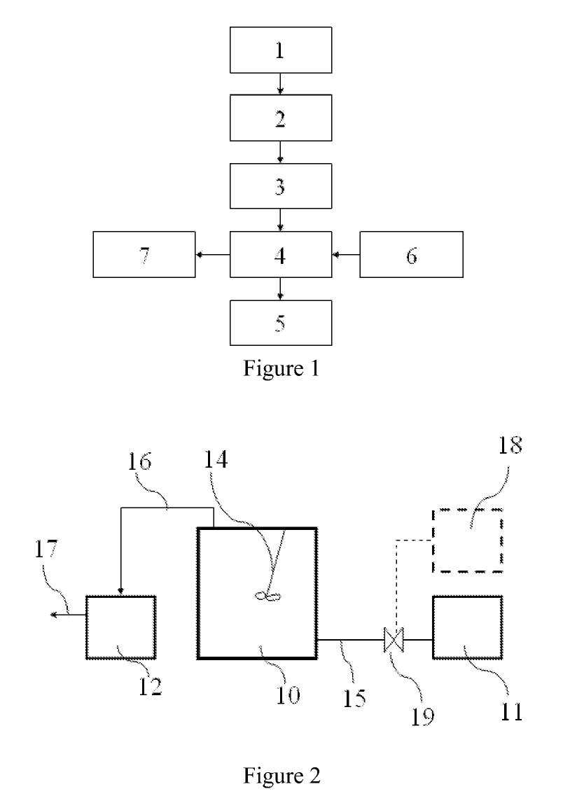

FIG. 1 shows a schematic process diagram of the method. In block 1 the electrically insulating oil is removed from the electrical apparatus. Block 2 is the optional step to clean the inside of the apparatus of remaining electrically insulating oil, for example, by spraying or washing the inside of the electrical apparatus with solvents or by condensation of solvent vapor on the inside of the apparatus and then removing the oil/solvent solution.

Block 3 is the optional step to pre-treat the copper sulphide deposits on the materials and surfaces in the electrical apparatus with a substitution agent to facilitate the oxidation reaction, an example of possible substitution agents are elementary iodine vapor or hydrogen iodide.

In block 4 the oxidation reaction (treatment) of the copper sulphide on the materials and surfaces occurs. The reaction transforms the semi-conducting copper sulphide on the materials and surfaces in the electrical apparatus to mainly non-conducting copper sulphate. The oxidizing agent from block 6 is fed into the electrical apparatus and in block 7 the un-reacted oxidizing agent is destroyed.

Examples of possible oxidizing agents that can be used are; ClO₂, ozone or peroxycetic acid

In block 5 the treatment is completed and the electrical apparatus is filled with electrically insulating oil and can be put in operation again.

FIG. 2 illustrates a flowchart of one embodiment of the invention. In this flowchart the oil has been removed from the electrical apparatus 10 before the treatment and the treatment can start. An oxidizing agent storage or generation means 11 supplies the necessary oxidizing agent, in gas phase, for the reaction to occur. The oxidizing agent is fed 15 into the electrical apparatus 10 where the atmosphere is controlled with respect to parameters such as; humidity, temperature, oxidizing agent concentration, nitrogen and oxygen content.

Examples of possible oxidizing agents that can be used are; ClO₂, ozone or peroxycetic acid.

If the oxidizing agent is ClO₂, the processes have to be controlled so that the ClO₂ concentration in the generation or storage as well as inside the electrical apparatus does not exceed 15 vol-% since above this concentration ClO2 may explosively decomposes into chlorine and oxygen.

The atmosphere in the electrical apparatus 10 has to be mixed to assist the diffusion of the oxidizing agent onto materials and surfaces inside the electrical apparatus that is to be treated to ensure that the reaction rate is sufficient. In the flowchart one possibility of mixing the atmosphere is shown as an internal mixer or fan 14 inside the electrical apparatus 10. Un-reacted oxidizing agent and excess atmosphere is removed 16 and fed into a destructor 12 that removes/reacts with the remaining oxidizing agent leaving only harmless byproducts 17.

If the copper sulphide deposits on the materials and surfaces in the electrical apparatus are pre-treated with a substitution agent to facilitate the oxidation reaction, the flowchart comprises substitution agent storage means 18 which supplies the necessary substitution agent, in gas phase, for the substitution reaction to occur. A valve means 19 is used to select which agent is injected in the electrical apparatus 10.

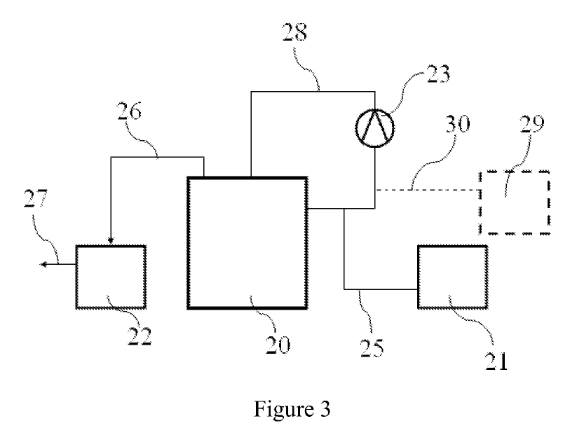

FIG. 3 illustrates a flowchart of one embodiment of the invention. In this flowchart the oil has been removed from the electrical apparatus 20 and the treatment can start. An oxidizing agent storage or generation means 11 supplies the necessary oxidizing agent for the reaction to occur. The oxidizing agent is fed 25 into the circulation cycle 28 used for mixing oxidizing agent with the atmosphere inside the apparatus. The atmosphere in the electrical apparatus 20 is controlled, with respect to parameters such as; humidity, temperature, oxidizing agent concentration, nitrogen and oxygen content.

The atmosphere in the electrical apparatus 10 has to be mixed to assist the diffusion of the oxidizing agent onto materials and surfaces inside the electrical apparatus that is to be treated to ensure that the reaction rate is sufficient. In the flowchart one possibility of mixing the atmosphere is shown as a circulation cycle 28 with a pump 23. Un-reacted oxidizing agent and excess atmosphere is removed 26 and fed into a destructor 22 that removes/reacts with the remaining oxidizing agent leaving only harmless byproducts 27.

If the copper sulphide deposits on the materials and surfaces in the electrical apparatus are pre-treated with a substitution agent to facilitate the oxidation reaction, the flowchart comprises substitution agent storage means 28 which supplies 30 the necessary substitution agent, in gas phase, to the circulation cycle 28 for the substitution reaction in the apparatus 20 to occur.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method of treating copper sulfide deposits on materials and surfaces that are in contact with electrically insulating oil inside an electrical apparatus, wherein a substantial amount of an electrically insulating oil, normally present in said electrical apparatus, have been removed, the method comprising:
subjecting said copper sulphide deposits on materials and surfaces to treatment with a gaseous oxidizing agent causing a reaction with the copper sulphide.

2. The method according to claim 1, wherein the gaseous oxidizing agent comprises chlordioxide, ClO₂.

3. The method according to claim 1, wherein the gaseous oxidizing agent comprises a peroxy acid.

4. The method according to claim 3, wherein said peroxy acid comprises peracetic acid, C₂H₄O₃.

5. The method according to claim 3, wherein said peroxy acid comprises performic acid, CH₂O₃.

6. The method according to claim 1, wherein the gaseous oxidizing agent is ozone, O₃.

7. The method according to claim 1, further comprising:
treating the materials and surfaces of the electrical apparatus with a substitution agent comprising halogen prior to the treatment with the oxidizing agent.

8. The method method according to claim 7, wherein the substitution agent comprises an elementary halogen.

9. The method according to claim 8, wherein said substitution agent comprises iodine, I₂.

10. The method according to claim 8, wherein said substitution agent comprises chlorine, Cl₂.

11. The method according to claim 7, wherein said substitution agent comprises hydrogen iodide, HI.

12. The method according to claim 1, further comprising:
removing all remaining, and
further cleaning the inside of the electrical apparatus utilizing a liquid in which the electrically insulating oil is soluble before the treatment.

13. The method according to claim 1, wherein the treatment with the agent is performed in a controlled atmosphere.

14. The method according to claim 1, further comprising:
introducing a non-reactive gas into the electrical apparatus to control the atmosphere.

15. The method according to claim 1, further comprising:
heating the electrical apparatus during treatment with a current flowing through the conductors.

16. The method according to claim 1, further comprising:
heating the electrical apparatus during treatment the electrical apparatus with external heaters.

17. The method according to claim 1, wherein during treatment, the gaseous oxidizing agent is distributed in the atmosphere inside the electrical apparatus.

18. The method according to claim 17, wherein distribution of gaseous oxidizing agent is done by a mixing means placed inside the electrical apparatus of any of the types; fan, agitator, pump.

19. The method according to claim 17, wherein distribution of gaseous oxidizing agent comprises extracting part of the atmosphere in the electrical apparatus and feeding the extracted part back to said electrical apparatus and creating a turbulent atmosphere in the apparatus.

20. The method according to claim 1, wherein a copper compound, formed as a result of the copper sulfide being treated with said gaseous oxidizing agent, is allowed to remain on materials and surfaces inside of the electrical apparatus, and wherein the electrical apparatus is re-filled with electrically insulating oil.

21. The method according to claim 1, wherein un-reacted gaseous oxidizing agent leaving the electrical apparatus is fed into a destructor that transforms the agent to less active substances.

22. A system for treating copper sulfide deposits on materials and surfaces inside an electrical apparatus that have been in contact with electrically insulating oil normally present in the electrical apparatus wherein said electrical apparatus is mostly empty of oil and, said system comprising:
a feed for introducing a gaseous chemical agent into said electrical apparatus, and,
a drain for removing excess atmosphere from said electrical apparatus.

23. The system according to claim 22, wherein said feed for introducing a gaseous chemical agent comprises a temporary connection between a source of chemical agent and the apparatus.

24. The system according to claim 22, wherein said gaseous chemical agent can be either an oxidizing agent comprising chlordioxide, peracetic acid, performic acid, ozone; or a substitution agent comprising iodine or chlorine.

25. The system according to claim 22 wherein said drain for removing excess atmosphere comprises a temporary connection between the apparatus and a destructor that transforms the active components in the apparatus atmosphere to less active components.

26. The system according to claim 22, further comprising:
a feed for introducing a non-reactive gas into the apparatus.

27. The system according to claim 22, further comprising:
a heater configured to heat the apparatus.

28. The system according to claim 22, further comprising:
a mixer configured to mix the atmosphere in the apparatus.
